(19) United States
(12) Patent Application Publication
(10) Pub. No.: US 2008/0012541 A1
(43) Pub. Date: Jan. 17, 2008

(54) Voltage generator and power supply circuit

(76) Inventors: Yoshikazu Sasaki, Kyoto-shi (JP); Isao Yamamoto, Kyoto-shi (JP)

Correspondence Address: CANTOR COLBURN, LLP, 55 GRIFFIN ROAD SOUTH, BLOOMFIELD, CT, 06002, US

(21) Appl. No.: 11/818,745

(22) Filed: Jun. 15, 2007

(30) Foreign Application Priority Data
Jun. 16, 2006 (JP) P2006-167824

(51) Int. Cl. G05F 1/618

(52) U.S. Cl. 323/265

(57) ABSTRACT

A voltage generator according to the present invention includes a reference voltage generator and a reference voltage determination circuit. The reference voltage generator outputs a detection current when generating a predetermined reference voltage by a passage of an electric current having a predetermined current value or higher. The reference voltage determination circuit detects or predetects an anomaly in the reference voltage in accordance with the detection current outputted by the reference voltage generator, and then outputs a determination signal.

### CROSS REFERENCE TO RELATED APPLICATION

This application is based upon and claims the benefit of priority from prior Japanese Patent Application P2006-167824 filed on Jun. 16, 2006; the entire contents of which are incorporated by reference herein.

### BACKGROUND OF THE INVENTION

1. Field of the Invention

The present invention relates to a voltage generator for generating a reference voltage and a power supply circuit including the voltage generator.

2. Description of the Related Art

A reference voltage generator (or a voltage generator) for inputting a reference voltage to a regulator or the like for outputting a constant voltage, and a power supply circuit including the voltage generator has been known.

Japanese Patent Publication No. H7-281769, for example, discloses a power supply circuit including a reference voltage generator, a voltage comparator, a voltage detector and a switching circuit. In the power supply circuit, the reference voltage generator inputs a reference voltage to the voltage comparator. The voltage detector inputs a supply voltage based on an output voltage to the voltage comparator.

Then, the voltage comparator makes a comparison between the reference voltage and the supply voltage, and the switching circuit is controlled in accordance with the result of the comparison. Thereby, the output voltage from the switching circuit is kept at a constant voltage value.

Further known is a power supply circuit including the reference voltage generator mentioned above which employs a band gap reference circuit (hereinafter referred to simply as a “BGR circuit”). In a reference voltage generator 58 formed of the BGR circuit as shown in FIG. 1, for example, part of a constant current I₁₁ from a constant-current source 65 supplied with an input of a battery voltage Vbat is fed as electric currents I₁₂ and I₁₃ to transistors Q₁₁ and Q₁₂ through resistors R₁₁ and R₁₂ of a current mirror circuit CM11, and the rest is fed as an electric current I₁₄ to a transistor Q₁₃.

The reference voltage generator 58, when supplied with the constant current I₁₁ having a certain current value or higher, can make the electric currents I₁₂ and I₁₃ constant. The reference voltage generator 58, when supplied with the constant current I₁₁ having the given current value or higher from the constant-current source 65, can therefore keep an output reference voltage Vref constant. Incidentally, a stabilizing circuit SC₁ is configured to stabilize the electric currents I₁₂ and I₁₃.

In the power supply circuit including the reference voltage generator 58 employing the BGR circuit as mentioned above, however, the electric currents I₁₂ and I₁₃ drop when the occurrence of an abnormal condition in a battery or the like that supplies power to the reference voltage generator 58 causes a drop in the battery voltage Vbat and hence a drop in the constant current I₁₁ from the constant-current source 65 to below a predetermined current value.

As a result, the reference voltage generator 58 outputs the reference voltage Vref that is different from a predetermined voltage value. Even under such conditions, the voltage comparator makes a comparison between the reference voltage that is different from the predetermined voltage value and the supply voltage so as to control the switching circuit. This causes a drop in the output voltage, resulting in the problem of causing malfunctioning of electronics or the like connected to the power supply circuit.

Although a comparator may possibly be provided to make a judgment on the reference voltage Vref, the comparator also requires a reference voltage (hereinafter referred to as a “second reference voltage”) for comparison with the reference voltage Vref (hereinafter referred to as a “first reference voltage”). However, even if generated separately, the second reference voltage likewise undergoes variations due to abnormal battery conditions or the like. Even with the use of the second reference voltage for comparison with the first reference voltage, therefore, the comparator cannot accurately detect an anomaly in the first reference voltage.

### SUMMARY OF THE INVENTION

The present invention has been made to overcome the foregoing problems. It is an object of the present invention to provide a voltage generator capable of accurately detecting an anomaly in a reference voltage, and to provide a power supply circuit including the same.

To achieve the above object, a first feature of the present invention resides in a voltage generator includes a reference voltage generator and a reference voltage determination circuit. The reference voltage generator outputs a detection current when generating a predetermined reference voltage by a passage of an electric current having a predetermined current value or higher. The reference voltage determination circuit detects or predetects an anomaly in the reference voltage in accordance with the detection current outputted by the reference voltage generator, and outputs a determination signal.

A second feature of the present invention resides in the voltage generator according to the first feature of the present invention. The reference voltage generator includes a first current mirror circuit, a stabilizing circuit and a detecting transistor. The first current mirror circuit generates a reference voltage by a passage of part of the electric current. The stabilizing circuit stabilizes the reference voltage generated by the first current mirror circuit. Then the detecting transistor detects, as the detection current, the rest of the electric current excluding the part of the electric current for generating the reference voltage with the first current mirror circuit. In addition, the reference voltage determination circuit outputs the determination signal indicating the detection of the anomaly, when the detection current is smaller than a predetermined value.

A third feature of the present invention resides in the voltage generator according to the second feature of the present invention, and further includes first to third constant-current sources supplied with a power supply voltage. The first current mirror circuit includes first, second and third resistors and first and second transistors. The first and second resistors are each connected at one end to the first constant-current source. The third resistor is connected at one end to a ground. In the first transistor, a collector and a base are connected to the other end of the first resistor, and an emitter is grounded. In the second transistor, a collector is connected to the other end of the second resistor, a base is connected to the base of the first transistor, and an emitter is connected to the other end of the third resistor. The stabilizing Circuit includes a third transistor and a capacitor. In the third transistor, a collector is connected to the second constant-current source, a base is connected to the collector of the second transistor, and an emitter is grounded. The capacitor is connected between the collector and the base of the third transistor. The detecting transistor has an emitter connected to the first constant-current source, and a base connected to the collector of the third transistor. Then, the reference voltage determination circuit includes fourth and fifth transistors and an inverter. In the fourth transistor, a base and a collector are connected to a collector of the detecting transistor, and an emitter is grounded. In the fifth transistor, a collector is connected to the third constant-current source, a base is connected to the base of the fourth transistor, and an emitter is grounded. The inverter is connected to the collector of the fifth transistor.

A fourth feature of the present invention resides in a power supply circuit and includes a reference voltage generator, a reference voltage determination circuit, a regulator, a starting controller and an on-off input circuit. The reference voltage generator outputs a detection current when generating a predetermined reference voltage by a passage of an electric current having a predetermined current value or higher. The reference voltage determination circuit detects or predetects an anomaly in the reference voltage in accordance with the detection current outputted by the reference voltage generator, and outputs a determination signal. The regulator is supplied with an input of the reference voltage from the reference voltage generator. The starting controller outputs a staring signal for controlling the regulator. The on-off input circuit inputs an on-off signal to the regulator in accordance with the determination signal from the reference voltage determination circuit and the starting signal from the starting controller.

A fifth feature of the present invention resides in the power supply circuit according to the fourth feature of the present invention. The reference voltage generator includes a first current mirror circuit, a stabilizing circuit, a detecting transistor. The first current mirror circuit generates a reference voltage by a passage of part of the electric current. The stabilizing circuit stabilizes the reference voltage generated by the first current mirror circuit. Then, the detecting transistor detects, as the detection current, the rest of the electric current excluding the part of the electric current for generating the reference voltage with the first current mirror circuit. The reference voltage determination circuit outputs the determination signal indicating the detection of the anomaly, when the detection current is smaller than a predetermined value.

A sixth feature of the present invention resides in the power supply circuit according to the fifth feature of the present invention, and further includes first to third constant-current sources supplied with a power supply voltage. The first current mirror circuit includes first, second and third resistors and first and second transistors. The first and second resistors are each connected at one end to the first constant-current source. The third resistor is connected at one end to a ground. In the first transistor, a collector and a base are connected to the other end of the first resistor, and an emitter is grounded. In the second transistor, a collector is connected to the other end of the second resistor, a base is connected to the base of the first transistor, and an emitter is connected to the other end of the third resistor. Then, the stabilizing circuit includes a third transistor and a capacitor. In the third transistor, a collector is connected to the second constant-current source, a base is connected to the collector of the second transistor, and an emitter is grounded. The capacitor is connected between the collector and the base of the third transistor The detecting transistor has an emitter connected to the first constant-current source, and a base connected to the collector of the third transistor. In addition, the reference voltage determination circuit includes fourth and fifth transistors and an inverter. In the fourth transistor, a base and a collector are connected to a collector of the detecting transistor, and an emitter is grounded. In the fifth transistor, a collector is connected to the third constant-current source, a base is connected to the base of the fourth transistor, and an emitter is grounded. The inverter is connected to the collector of the fifth transistor.

According to the present invention, the reference voltage determination circuit determines the reference voltage in accordance with the detection current outputted by the reference voltage generator. Thus, the circuit of the present invention can reliably detect or predetect an anomaly in the reference voltage, as compared to a case in which the reference voltage is determined by using a comparator or the like. Moreover, the circuit of the present invention can suppress an increase in power consumption because of using an over current, which has not heretofore been used, for detection of the anomaly in the reference voltage.

### BRIEF DESCRIPTION OF THE DRAWINGS

FIG. 1 is a circuit diagram showing a conventional reference voltage generator;

FIG. 2 is a diagram showing the general configuration of a power supply circuit according to an embodiment of the present invention; and

FIG. 3 is a circuit diagram of a voltage generator according to the embodiment of the present invention.

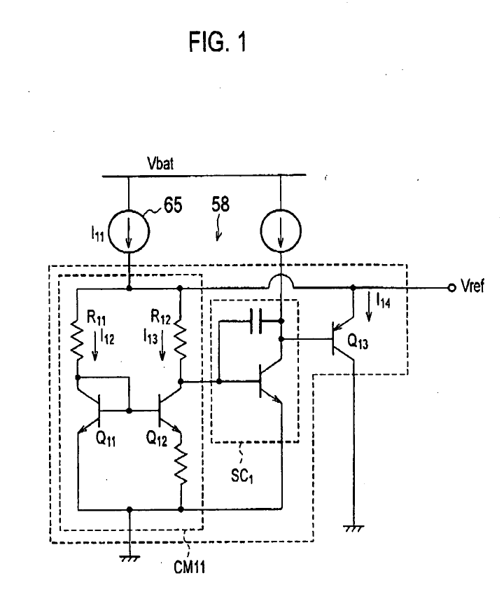

### DESCRIPTION OF THE PREFERRED EMBODIMENTS

Various embodiments of the present invention will be described with reference to the accompanying drawings. It is to be noted that the same or similar reference numerals are applied to the same or similar parts and elements throughout the drawings, and description of the same or similar parts and elements will be omitted or simplified. In the following descriptions, numerous specific details are set forth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention with unnecessary detail.

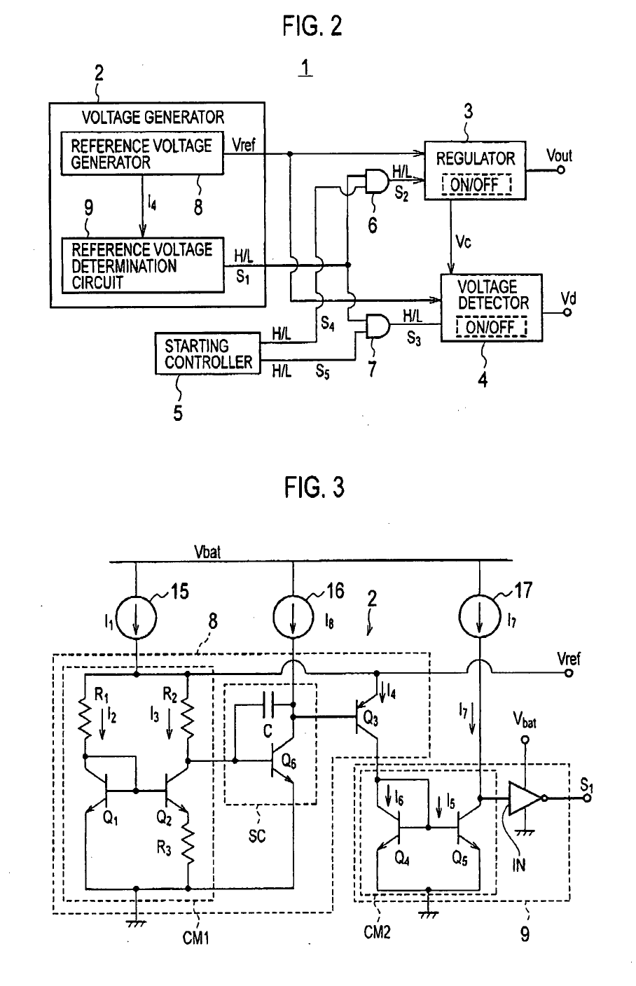

FIG. 2 is a diagram showing the general configuration of a power supply circuit according to an embodiment of the present invention. FIG. 3 is a circuit diagram of a voltage generator according to the embodiment of the present invention.

As shown in FIG. 2, a power supply circuit 1 includes a voltage generator 2, a regulator 3, a voltage detector 4, a starting controller 5, and two AND circuits 6 and 7.

The voltage generator 2 includes a reference voltage generator 8 and a reference voltage determination circuit 9.

The reference voltage generator 8 is configured to output a reference voltage Vref to the regulator 3 and the voltage detector 4. As shown in FIG. 3, the reference voltage generator 8 is formed of a BGR circuit including a current mirror circuit CM1, a transistor Q₃ for detection current, and a stabilizing circuit SC. The current mirror circuit. CM1 includes a pair of transistors Q₁ and Q₂ and resistors R₁ to R₃. The current mirror circuit CM1 and the transistor Q₃ are supplied with a constant current I₁ from a constant-current source 15, and the stabilizing circuit SC is supplied with a constant current I₈ from a constant-current source 16. The stabilizing circuit SC includes a capacitor C and a transistor Q₆.

The reference voltage determination circuit 9 includes a current mirror circuit CM2 including a pair of transistors Q₄ and Q₅, and an inverter IN. The transistor Q₅ and the inverter IN are supplied with a constant current I₇ from a constant-current source 17, When the reference voltage determination circuit 9 determines that there is no anomaly in the reference voltage Vref, the circuit 9 outputs a determination signal S₁ at a H (high) level (hereinafter, a level will be simply indicated by an adjective, HIGH or LOW) to the AND circuits 6 and 7.

When the reference voltage determination circuit 9 determines the presence or occurrence of an anomaly in the reference voltage Vref, the circuit 9 outputs a LOW determination signal S₁ to the AND circuits 6 and 7. Incidentally, the constant-current sources 15 to 17 are supplied with an input of a battery voltage Vbat from a battery (not shown).

The regulator 3 is configured to make a comparison between the reference voltage Vref, inputted from the reference voltage generator 8 of the voltage generator 2, and a feedback voltage (not shown), fed back based on an output voltage Vout, and to output the output voltage Vout having a given voltage value to electronics or the like connected to the output end. The regulator 3 is supplied with an input of an on-off signal S₂ from the AND circuit 6 so that the regulator 3 is turned on or off under control of the on-off signal S₂.

The voltage detector 4 is configured to make a comparison between the reference voltage Vref, inputted front the reference voltage generator 8 of the voltage generator 2, and a comparative voltage Vc based on the output voltage Vout from the regulator 3, and to output a detection voltage Vd indicating an anomaly in the output voltage Vout in accordance with the result of the comparison.

Specifically, when the comparative voltage Vc is higher than the reference voltage Vref, the output voltage Vout is judged as being higher than a predetermined voltage value, and a HIGH detection voltage Vd is outputted. When the comparative voltage Vc is lower than the reference voltage Vref, the output voltage Vout is judged as being lower than the predetermined voltage value, and a LOW detection voltage Vd is outputted. The voltage detector 4 is supplied with an input of an on-off signal S₃ from the AND circuit 7 so that the voltage detector 4 is turned on or off under control of the on-off signal S₃.

The starting controller 5 is configured to perform drive control on the regulator 3 and the voltage detector 4. To turn on the regulator 3 and the voltage detector 4, the starting controller 5 sends a HIGH starting signal S₄ to the AND circuit 6, and also sends a HIGH starting signal S₅ to the AND circuit 7. To turn off the regulator 3 and the voltage detector 4, the starting controller 5 sends a LOW starting signal S₄ to the AND circuit 6, and also sends a LOW starting signal S₅ to the AND circuit 7.

The AND circuit 6 (which corresponds to an on-off input circuit as defined in claim 4) is configured to input the on-off signal S₂ to the regulator 3 in accordance with the determination signal S₁ from the reference voltage determination circuit 9 and the starting signal S₄ from the starting controller 5.

Specifically, the AND circuit 6, when supplied with the inputs of the HIGH determination signal S₁ and the HIGH starting signal S₄, inputs a HIGH on signal S₂ to the regulator 3. The AND circuit 6, when supplied with the inputs of the determination signal S₁ and the starting signal S₄, at least one of which is LOW, inputs a LOW off signal S₂ to the regulator 3.

The AND circuit 7 is configured to input the on-off signal S₃ to the voltage detector 4 in accordance with the determination signal S₁ from the reference voltage determination circuit 9 and the starting signal S₅ from the starting controller 5. Specifically, the AND circuit 7, when supplied with the inputs of the HIGH determination signal S₁ and the HIGH starting signal S₅, inputs a HIGH on signal S₃ to the voltage detector 4. The AND circuit 7, when supplied with the inputs of the determination signal S₁ and the starting signal S₅, at least one of which is LOW, inputs a LOW off signal S₃ to the voltage detector 4.

Description will now be given with regard to operation of the power supply circuit 1, centering on operation of the voltage generator 2, provided that the starting controller 5 inputs HIGH signals (namely on signals) to both the AND circuits 6 and 7.

In the power supply circuit 1, when the current mirror circuit CM1 is supplied with the constant current I₁ from the constant-current source 15, currents I₂ and I₃ are fed through the resistors R₁ and R₂ to the transistors Q₁ and Q₂, respectively. Incidentally, the current values of the currents I₂ and I₃ are stabilized by the stabilizing circuit SC.

When the electric current I₁ having a predetermined current value or higher is fed from the constant-current source 15 to the reference voltage generator 8, that is, when I₁ exceeds the maximum value of I₂ plus I₃ (I₁>the maximum value of I₂+I₃), the electric currents I₂ and I₃ pans through the circuit while maintaining the maximum value. Thereby, the reference voltage Vref having the predetermined voltage value is outputted while being kept constant. Incidentally, the maximum value of the current values of the electric currents I₂ and I₃ is a fixed value determined by the resistance values of the resistors R₁ to R₃, the characteristics of the transistors Q₁ and Q₂, a Boltzmann constant, a temperature, and so on.

When I₁>the maximum value of I₂+I₃, the constant current I₁ is partially fed as a detection current I₄ (=I₁−I₂−I₃) to a collector of the transistor Q₃. Further, the detection current I₄ is fed through the transistor Q₃ to the transistors Q₄ and Q₅.

Then, the detection current I₄ is partially fed as an electric current I₅ to a base of the transistors Q₄ and Q₅ to turn on the transistors Q₄ and Q₅. Thereby, the detection current I₄ is partially fed as an electric current I₆ to a collector of the transistor Q₄, and the constant current I₇ from the constant-current source 17 is partially or wholly fed through the transistor Q₅. Incidentally, the current value of the constant current I₇ is set so that I₇ is less than the maximum value of I₆ (I₇<the maximum value of I₆).

Here, the electric current I₆ fed to the collector of the transistor Q₄ also has a current value that satisfies the equation I₇<I₆, because the sufficiently large detection current I₄ is fed correspondingly under conditions where the battery outputs the battery voltage Vbat having a normal voltage value, and where the current value of the constant current I₁ is sufficiently large.

Therefore, an electric current having the same current value as the electric current I₆ larger than the constant current I₇ is to be fed to a collector of the transistor Q₅ that is paired with the transistor Q₄ to form the current mirror circuit CM2, and thus a LOW signal is inputted to the inverter IN. As a result, a determination is made that the battery voltage Vbat is normally outputted and the reference voltage Vref is normally outputted (which will be hereinafter referred to simply as a “normal condition”), and the inverter IN outputs the HIGH determination signal S₁.

When a decrease in the current value of the constant current I₁ takes place due to a decrease in the voltage value of the battery voltage Vbat outputted by the battery or the like, the current value of the detection current I₄ becomes small or the passage of the detection current I₄ is stopped. Under this condition, the current value of the electric current I₆ fed to the transistor Q₄ is smaller than that of the constant current I₇ (I₇>I₆).

Thereby, an electric current having the same current value as the electric current I₆ smaller than the constant current I₇ is to be fed to the collector of the transistor Q₅ that is paired with the transistor Q₄ to form the current mirror circuit CM2, and thus a HIGH signal is inputted to the inverter IN. As a result, a determination is made that the voltage value of the reference voltage Vref is anomalous, or is about to drop and become anomalous, due to a drop in the battery voltage Vbat or the like (which will be hereinafter referred to simply as an “abnormal condition”), and the inverter IN outputs the LOW determination signal.

Incidentally, the current value of the electric current I₇ may be appropriately changed. As is apparent from the above, the electric current I₇ having a larger current value enables earlier predetection of an anomaly in the reference voltage Vref, while the electric current I₇ having a current value closer to zero leads to the shorter time between the detection of the anomaly and the occurrence of the anomaly in the reference voltage Vref.

Under the normal condition, consequently, the starting controller 5 inputs the HIGH starting signals S₄ and S₅ to the AND circuits 6 and 7, respectively, and the reference voltage determination circuit 9 inputs the HIGH determination signal S₁ to the AND circuits 6 and 7. Thus, the AND circuits 6 and 7 input the HIGH on signals S₂ and S₃ to the regulator 3 and the voltage detector 4, respectively, so that the regulator 3 and the voltage detector 4 are turned on.

Under the abnormal condition, the AND circuits 6 and 7, even if supplied with the inputs of the HIGH starting signals S₄ and S₅, respectively, from the starting controller 5, receive the input of the LOW determination signal S₁ from the reference voltage determination circuit 9. Thus, the AND circuits 6 and 7 input the LOW off signals S₂ and S₃ to the regulator 3 and the voltage detector 4, respectively, so that the regulator 3 and the voltage detector 4 are turned off.

As mentioned above, the voltage generator 2 of the power supply circuit 1 according to the embodiment of the present invention includes the reference voltage determination circuit 9 that detects the presence or occurrence of an anomaly in the reference voltage Vref outputted by the reference voltage generator 8, through the electric current I₆ based on the detection current I₄. Thereby, the circuit of the present invention can reliably detect the presence or occurrence of the anomaly in the reference voltage Vref.

Consequently, the circuit of the present invention can prevent an anomaly in the output voltage Vout outputted from the regulator 3, involved in the anomaly in the reference voltage Vref, and hence prevent malfunctioning of electronics connected to the regulator 3. Moreover, the circuit of the present invention can suppress an increase in power consumption because of using the detection current I₄, which has not heretofore been used, for detection of the anomaly in the reference voltage Vref.

While this invention has been described in detail in connection with the above embodiment, it should be apparent that the invention is not to be limited to the embodiment described herein. It is to be understood that within the spirit and scope of the appended claims the invention may be modified and practiced otherwise than as specifically described. It is to be understood that the disclosure herein is illustrative only and not restrictive of the scope of the invention. Description will be given below with regard to a modified form of the above embodiment.

In the above embodiment, the voltage generator is configured to determine the occurrence of an anomaly in the reference voltage Vref and output the LOW determination signal S₁, when the electric current I₆ is smaller than the electric current I₅. However, the voltage generator may be configured to output the LOW determination signal S₁ indicative of the anomaly, only when the electric current I₆ is zero and the reference voltage Vref is already anomalous.

What is claimed is:

1. A voltage generator comprising:
a reference voltage generator configured to output a detection current when generating a predetermined reference voltage by a passage of an electric current having a predetermined current value or higher; and
a reference voltage determination circuit configured to detect or predetect an anomaly in the reference voltage in accordance with the detection current outputted by the reference voltage generator, and to output a determination signal.

2. The voltage generator according to claim 1, wherein
the reference voltage generator includes:
a first current mirror circuit configured to generate a reference voltage by a passage of part of the electric current;
a stabilizing circuit configured to stabilize the reference voltage generated by the first current mirror circuit; and
a detecting transistor configured to detect, as the detection current, the rest of the electric current excluding the part of the electric current, and
the reference voltage determination circuit outputs the determination signal indicating the detection of the anomaly, when the detection current is smaller than a predetermined value.

3. The voltage generator according to claim 2, further comprising first to third constant-current sources each supplied with a power supply voltage, wherein
the first current mirror circuit includes:
first and second resistors each connected at one end to the first constant-current source;
a third resistor connected at one end to a ground;
a first transistor having a collector and a base connected to the other end of the first resistor, and an emitter grounded; and
a second transistor having a collector connected to the other end of the second resistor, a base connected to the base of the first transistor, and an emitter connected to the other end of the third resistor,
the stabilizing circuit includes:
a third transistor having a collector connected to the second constant-current source, a base connected to the collector of the second transistor, and an emitter grounded; and
a capacitor connected between the collector and the base of the third transistor,
the detecting transistor includes:
an emitter connected to the first constant-current source; and
a base connected to the collector of the third transistor, and the reference voltage determination circuit includes:
a fourth transistor having a base and a collector connected to the collector of the detecting transistor, and an emitter grounded;
a fifth transistor having a collector connected to the third constant-current source, a base connected to the base of the fourth transistor, and an emitter grounded; and
an inverter connected to the collector of the fifth transistor.

4. A power supply circuit comprising:
a reference voltage generator configured to output a detection current when generating a predetermined reference voltage by a passage of an electric current having a predetermined current value or higher;
a reference voltage determination circuit configured to detect or predetect an anomaly in the reference voltage in accordance with the detection current outputted by the reference voltage generator, and to output a determination signal;
a regulator supplied with an input of the reference voltage from the reference voltage generator;
a starting controller configured to output a starting signal for controlling the regulator; and
an on-off input circuit configured to input an on-off signal to the regulator in accordance with the determination signal from the reference voltage determination circuit and the starting signal from the starting controller.

5. The power supply circuit according to claim 4, wherein
the reference voltage generator includes:
a first current mirror circuit configured to generate a reference voltage by a passage of part of the electric current;
a stabilizing circuit configured to stabilize the reference voltage generated by the first current mirror circuit; and
a detecting transistor configured to detect, as the detection current, the rest of the electric current excluding the part of the electric current, and
the reference voltage determination circuit outputs the determination signal indicating the detection of the anomaly, when the detection current is smaller than a predetermined value.

6. The power supply circuit according to claim 5, further comprising first to third constant-current sources each supplied with a power supply voltage, wherein
the first current mirror circuit includes:
first and second resistors each connected at one end to the first constant-current source;
a third resistor connected at one end to a ground;
a first transistor having a collector and a base connected to the other end of the first resistor, and an emitter grounded; and
a second transistor having a collector connected to the other end of the second resistor, a base connected to the base of the first transistor, and an emitter connected to the other end of the third resistor,
the stabilizing circuit includes:
a third transistor having a collector connected to the second constant-current source, a base connected to the collector of the second transistor, and an emitter grounded; and
a capacitor connected between the collector and the base of the third transistor,
the detecting transistor includes:
an emitter connected to the first constant-current source; and
a base connected to the collector of the third transistor, and
the reference voltage determination circuit includes:
a fourth transistor having a base and a collector connected to the collector of the detecting transistor, and an emitter grounded;
a fifth transistor having a collector connected to the third constant-current source, a base connected to the base of the fourth transistor, and an emitter grounded; and
an inverter connected to the collector of the fifth transistor.
